(19) United States
(12) Patent Application Publication
(10) Pub. No.: US 2004/0144811 A1
(43) Pub. Date: Jul. 29, 2004

(54) Fluid dispenser

(75) Inventor: Herve Pennaneac'H, Piseux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 10/743,022

(22) Filed: Dec. 23, 2003

Related U.S. Application Data
(60) Provisional application No. 60/459,621, filed on Apr. 3, 2003.

(30) Foreign Application Priority Data
Dec. 23, 2002 (FR) FR-02/16549

(51) Int. Cl. A62C 11/00

(52) U.S. Cl. 222/633; 239/363

(57) ABSTRACT

A fluid dispenser comprising:

a reservoir (16; 26; 36; 46) of fluid and of gas;

a spraying orifice (310; 70);

an actuating wall (61, 62; 61′; 61″; 62″) for reducing the volume of the reservoir so as to put the gas and the fluid under pressure, thereby delivering them together as a mixture through the spraying orifice; and

a piece of porous material (5; 5′; 5″; 5″′) suitable for being impregnated with the fluid and with the gas and placed in the vicinity of the spraying orifice;

said fluid dispenser being characterized in that it further comprises capillary feed means (51; 25; 35; 45) for acting by capillary action to feed the piece of porous material with the fluid contained in the reservoir, said feed means being continuously in contact with the fluid product in the reservoir.

### CROSS REFERENCE TO RELATED APPLICATION

This application claims the benefit under 35 U.S.C. §119(e) of pending U.S. provisional patent application Serial No. 60/459,621, filed Apr. 3, 2003, and priority under 35 U.S.C. §119(a)-(d) of French patent application No. FR-02.16549, filed Dec. 23, 2002.

### TECHNICAL FIELD OF THE INVENTION

The present invention relates to a fluid dispenser comprising a reservoir of fluid and of gas, a spraying orifice, and an actuating wall for reducing the volume of the reservoir so-as to put the gas and the fluid under pressure, thereby delivering them together as a mixture through the spraying orifice. The term “fluid” is used herein to mean any liquid, fluid, or semi-liquid substance, and also, in certain cases, substances in powder form. Such a dispenser is, in particular, applicable to the fields of perfumes, of cosmetics, or even of pharmaceuticals.

### BACKGROUND OF THE INVENTION

Document FR-2 781 770 describes a dispenser of that type, comprising a reservoir formed between a substantially rigid shell and a sealing film. The shell defines an actuating wall that can be deformed by being pushed in. A supporting end-piece is also provided that supports a piece of porous material suitable for being impregnated with the fluid and with the gas. The supporting end-piece also forms a dispensing orifice, and more particularly a spraying orifice. The piece of porous material held by the supporting end-piece extends inside the reservoir which contains a small quantity of the fluid, i.e. of a liquid or a powder, and a larger quantity of gas, which is air in that dispenser. Thus, by pressing on the actuating wall of the reservoir, the internal volume of the reservoir is reduced, thereby putting the gas and the fluid with which the piece of porous material is impregnated under pressure. As a result, a mixture of the fluid and of air is delivered through the dispensing orifice in the form of a two-phase sprayed jet.

The piece of porous material is situated in the reservoir, but it is located in the immediate vicinity of or in direct contact with the dispensing orifice. Its purpose is to accumulate at least a fraction of the fluid in the immediate vicinity of the spraying orifice. Thus, most of the reservoir is occupied by the fluid and by air only. The fluid is retained inside the piece of porous material by capillary action. However, all of the fluid does not impregnate and lie inside the piece of porous material, so that a fraction of the fluid remains outside the piece of porous material inside the reservoir. If the dispenser is held so that the piece of porous material is not in contact with the fluid remaining inside the reservoir, and the dispenser is then actuated, after it has be actuated a few times, the piece of porous material does not contain any more fluid, so that it then sprays air only. To refill the piece of porous material with fluid, it is then necessary to shake the dispenser or to turn it upside-down so that the piece of porous material comes into contact again with the fluid stored inside the reservoir. Thus, the fluid can impregnate the piece of porous material once again.

### SUMMARY OF THE INVENTION

Thus, feeding the piece of material with fluid constitutes a significant problem when said piece of porous material is not soaking directly in the free fluid in the reservoir. An object of the present invention is to remedy that problem of the prior art by defining a dispenser in which the piece of porous material is automatically and unavoidably fed with fluid.

To solve that problem, the present invention makes provision for the dispenser to further comprise capillary feed means for acting by capillary action to feed the piece of porous material with the fluid contained in the reservoir, said feed means being continuously in contact with the fluid product in the reservoir. The feed means may extend through or around the reservoir, advantageously to the bottom of the reservoir, located at the opposite side of the spraying orifice. This guarantees that the piece of porous material is continuously impregnated with fluid so long as fluid remains in the reservoir.

In a first embodiment, the capillary feed means extend substantially through the middle of the reservoir. Advantageously, the capillary feed means comprise an absorbant wick in contact with or formed by the piece of porous material, and extending through the reservoir.

In another embodiment of the invention, the capillary feed means extend over at least a portion of the periphery of the reservoir. Advantageously, the feed means comprise at least one peripheral capillary channel having a discharge end in contact with the piece of porous material. Preferably, the capillary channel is open over substantially its entire length so that the fluid can penetrate into said channel over a large proportion of its length.

According to a characteristic which may be common to both of the preceding embodiments, the dispenser may further comprise a substantially rigid structure which extends over at least a portion of the periphery of the reservoir. This structure imparts stiffness to the dispenser so that the user can take hold of it more easily. In addition, it makes it possible to maintain the shape of the dispenser. Advantageously, said structure forms the capillary feed means. In certain cases, the structure may form the spraying orifice. Advantageously, the structure is provided with means for holding the porous piece in place in the reservoir. In a variant or in addition, the structure may form support means for supporting return spring means suitable for returning the actuating wall towards a rest position corresponding to the maximum volume of the reservoir. According to another advantageous characteristic of this structure, it may be made up of two component parts mounted one on the other, the feed means being formed between said parts. In which case, the feed means comprise capillary channels of cross-section that varies while the actuating wall is being actuated. In certain cases, the two component parts are identical.

In another aspect of the invention, the actuating wall is formed by a flexible sheet fixed in leaktight manner to said structure. In a variant, the actuating wall is formed by a flexible sheet encasing said structure in leaktight manner.

In a practical embodiment, the structure forms two peripheral capillary channels, each of which connects to the piece of porous material at a respective discharge end.

### BRIEF DESCRIPTION OF THE DRAWINGS

The invention is described more fully below with reference to the accompanying drawings which give embodiments of the invention by way of non-limiting example.

In the figures:

FIG. 1 is a perspective view of a first embodiment of a dispenser of the invention in the unfinished state so as to show the internal structure of the dispenser;

FIG. 2 is a perspective view of a second embodiment of a dispenser of the invention in the unfinished state also so as to show the internal structure of the dispenser;

FIG. 3 is another perspective view of a third embodiment of a dispenser of the invention with a portion cut away to show the internal structure of the dispenser;

FIG. 4 is a vertical section view on the section line A of FIG. 3;

FIG. 5 is a plan view of a fourth embodiment of a dispenser of the invention;

FIG. 6 is a perspective view of an element of the dispenser of FIG. 5; and

FIGS. 7 and 8 are views in vertical section of the dispenser of FIG. 5 respectively in the rest position and in the actuated position.

### DETAILED DESCRIPTION OF THE INVENTION

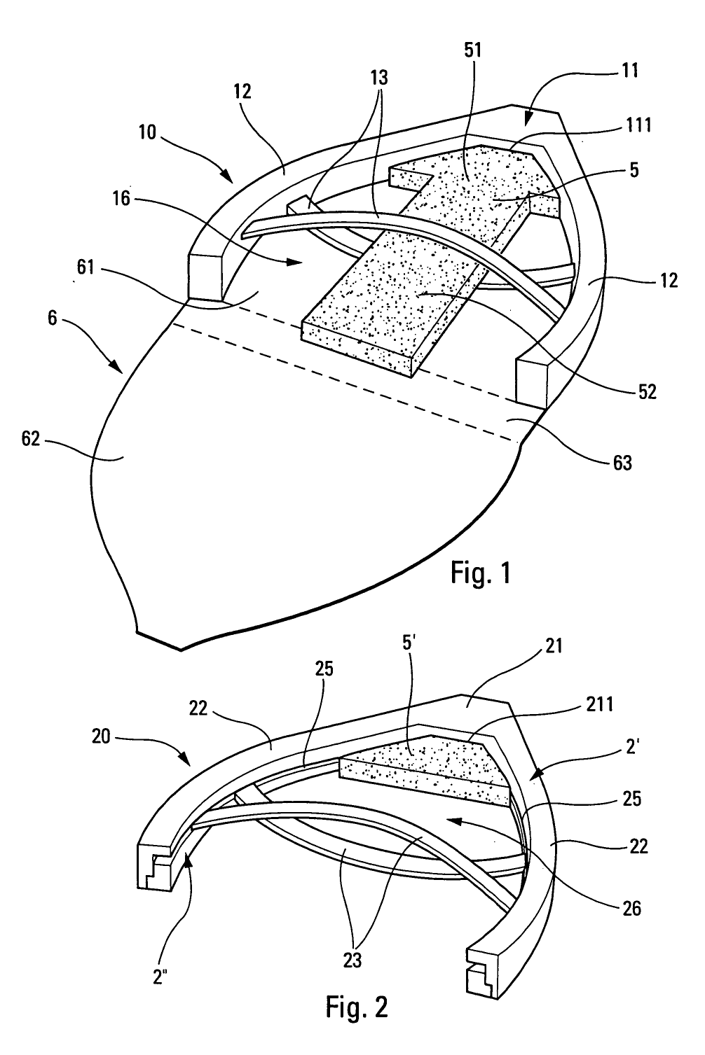

Reference is made firstly to FIG. 1 which shows the first embodiment of a dispenser of the invention. The dispenser in this example is made up of three component elements, namely a substantially rigid structure 10 advantageously made of a molded plastics material, a piece of porous material 5 and a piece of flexible sheet 6.

The structure 10 is in the general shape of an open U or of an open V. The structure 10 comprises a dispensing head 11 defining a spraying orifice (not shown) which opens out towards the background of FIG. 1. The spraying orifice is in communication with a holding recess 111 serving to receive a portion of the piece of porous material 5, as explained below. The dispensing head 11 serves as a junction element for two branches 12 which extend substantially symmetrically from the head 11. The two branches 12 point in substantially the same direction with their free ends. The two branches 12 and the head 11 together form a delimited internal space between them that corresponds roughly to the volume of a fluid and gas reservoir 16. The integral unit formed by the head 11 and by the two branches is substantially rigid. In other words, the two branches 12 are not easily deformable relative to each other and relative to the head 11. The holding recess 11 for holding the piece of porous material 5 is open towards the inside of the reservoir 16, i.e. between the two branches 12. According to an advantageous characteristic of the invention, the two branches 12 serve as supports for two elastically-deformable blades 13 which extend between the branches 12. Each blade 13 connects one branch 12 to the other branch 12. Advantageously, one blade 13 has an upward curvature while the other has a downward curvature, so that it can be said that one blade is convex and the other is concave or vice versa. The two blades 13 are significantly more flexible than the unit formed by the branches 12 and by the head 11. The curvature of each of the blades 13 is such that the blades do not lie within the internal space formed by the branches 12 and by the head 11. More particularly, the middle zone of each of the blades where the curvature is highest may be situated outside said delimited internal space. There are two flexible blades in this example, but it is also quite possible to provide three, four, or more blades. It is easy to understand that it is possible to reduce the respective curvatures of the blades by pressing on them so that they come closer together or at least tend to lie within a common plane, which is advantageously the plane of the unit formed by the branches 12 and by the head 11. In other words, by pressing on the blades 13, it is possible to deform them so that they lie within the delimited internal space.

In this example, the piece of porous material 5 is provided with an anchoring head 51 that is engaged at least in part in the holding recess 111 formed in the dispensing head 11. The anchoring head 51 advantageously extends into contact with the dispensing orifice (not shown). In the invention, the piece of porous material 5 also forms capillary feed means that, in this example, are in the form of a strip which extends from the anchoring head 51. Advantageously, said strip 52 extends between the two spring blades 13. The free end of the strip 52 is situated substantially at the same level as the free ends of the branches 12. It can be said that the capillary feed strip 52 extends substantially midway between the two branches 12. The strip 52 may be made integrally with the anchoring head 51. In a variant, it is possible to make provision for the strip 52 to be separate and mounted on or fixed to the anchoring head 51. The strip 52 thus acts as an absorbant or capillary wick in contact with the anchoring head of the piece of porous material. The anchoring head 51 and the strip 52 may be of the same nature. They must have absorption characteristics making it possible to retain a liquid by capillary action. In certain cases, it is even possible to imagine applications in which the piece of porous material and its feed means make it possible to absorb a powder.

The piece of sheet 6 defines a bottom sheet 61, a back 63 and a top sheet 62. The bottom sheet 61 is fixed under the branches 12 and under the head in leaktight manner, e.g. by heat-sealing. The back 63 is fixed in leaktight manner to the free ends of the branches 12, and the top sheet 62 serves to be fixed in leaktight manner to the branches 12 and to the head 11. Thus, the delimited internal space defined between the branches 12 is isolated from the outside, and thus forms a reservoir which can communicate with the outside only through the piece of porous material 5 and through the dispensing orifice (not shown). The piece of porous material 5 with its capillary strip 52 thus extends inside the reservoir 16 by passing through it. The reservoir 16 serves to contain a certain quantity of a fluid (preferably a fluid in liquid form) and a larger quantity of a gas (e.g. air). Thus, the piece of porous material 5, i.e. especially its anchoring head 51, can be impregnated with fluid and with air merely by capillary action. The sheets 61 and 62 cover the blades 13, and impart to them a certain amount of resistance to being pushed in. At a central zone, each of the sheets 61 and 62 defines a deformable actuating wall on which it is possible to press, e.g. with one or more fingers, in order to reduce the internal volume of the reservoir 16. Pushing in the actuating walls involves deforming the spring blades 13. As soon as the pressing ceases, the blades 13 return the actuating walls to the rest position in which the reservoir 16 defines a maximum volume. By pressing on the actuating walls and thereby reducing the internal volume of the reservoir 16, the air and the fluid inside the reservoir are subjected to pressure that causes the fluid and the air to be delivered through the dispensing orifice. In practice, it is the pressure exerted on the air inside the reservoir that delivers the fluid and the air stored inside the piece of porous material at the anchoring head 51, and more particularly at the holding recess 111. Normally, after the dispenser has been actuated a few times, the anchoring head 51 tends to be emptied of its fluid which is then progressively replaced by air. However, because of the capillary strip 52, the anchoring head 51 is always fed with fluid by capillary action which causes fluid, e.g. fluid stored at a place opposite from the dispensing orifice, to rise up towards the anchoring head 51 through the capillary strip 52. Thus, the capillary strip 52 acts as a genuine absorbant feed wick that conveys fluid to the anchoring head 51.

Although, in this example, the structure 10 has two branches 12, it is also possible to provide an alternative structure without any branches 12. The structure is then constituted merely by a dispensing head 11 serving as a support for the piece of porous material and to which the piece of sheet 6 is sealed in leaktight manner. However, it would be necessary to implement a return spring differently, e.g. in the form of a two-leaf strip of plastic or of metal.

Reference is made below to FIG. 2 to explain the second embodiment of the invention. The dispenser further comprises a substantially rigid structure 20 which has a general shape similar to that of the first embodiment shown in FIG. 1. The structure 20 comprises a dispensing head 21 forming a dispensing orifice (not shown) to which two branches 22 are integrally connected. The head 21 also forms a retaining recess 211 for retaining a piece of porous material 5′ which may have a shape substantially similar to the shape of the anchoring head 51 of the first embodiment. The structure 20 also forms two elastically deformable spring blades 23 which extend in a manner substantially similar to the manner of the first embodiment.

However, in the invention, the structure 20 is made up of two separate component parts 2′ and 2″ which are mounted one on the other and held together by interfitting. One component part 2′ defines the top faces and the peripheral walls of the branches 22 and of the head 21 in which the dispensing orifice (not shown) is formed. This component part 2′ also forms the outer portions of the bottom faces of the branches 22. This can be seen in FIG. 2. The second component part 2″ forms the inner edges of the bottom faces of the branches 22. The inside face formed between the two branches 22 is formed in part by the part 2′ and in part by the part 2″. However, the two parts 2′ and 2″ do not meet at the inside face defined inside the branches 22, but rather they co-operate to form a gap 25 which extends around the entire inside periphery of the branches 22. This is clearly visible in FIG. 2. Each branch 22 is thus provided with a gap 25 which extends from its free end to the piece of porous material 5′, and even to the retaining recess 211. In the invention, the two gaps 25 serve as capillary feed means in the form of capillary channels that extend over the inside periphery of the structure 20, and thus over the inside periphery of the reservoir 26. As in the preceding embodiment, the structure 20 serves to be encased in a sheet (not shown) which is sealed to the two faces of the first component part 2′. The sheet can also be sealed to the bottom face of the second component part 2″.

Because the gaps 25 are of very small width, they have capillary retention characteristics so that the fluid tends to remain stored inside the capillary feed channels. As a result, since each channel 25 has a discharge end in communication with the piece of porous material 5′, the liquid can be fed by capillary action from the end wall of the reservoir that is situated opposite from the head 21 to the piece of porous material 5′ so as to impregnate it.

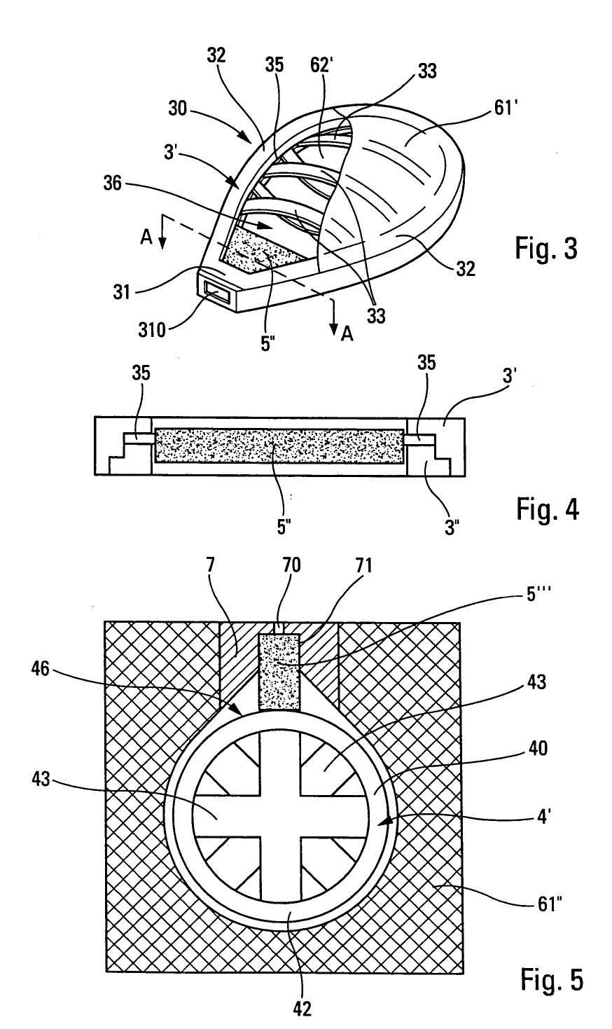

Reference is made below to FIGS. 3 and 4 which show a third embodiment of the invention that can be considered to be a variant of the second embodiment. In this example, the dispenser also comprises a rigid structure 30 that differs from the structure of the second embodiment shown in FIG. 2 by the fact that the two branches 32 of the structure 30 meet to form a sort of droplet-shaped loop. Another difference lies in the fact that the structure 30 has six elastically deformable spring blades 33 instead of two as it does in the preceding embodiments. Otherwise, the structure 30 has a dispensing head 31 forming a spraying dispensing orifice 310. The two branches 32 extend from the head 31 to meet, thereby forming a loop. As in the preceding embodiment, the structure 30 is made up of two component parts 3′ and 3″ which can have cross-sections substantially similar to the cross-sections of the component parts of the preceding embodiment. In other words, the first component part 3′ can form the top faces of the branches and of the head and the spraying orifice, while the part 3″ forms only a portion of the top face of each of the branches. The two parts 3′ and 3″ also co-operate to form between them a gap 25 that serves as a capillary feed channel which extends around the entire inside periphery of the structure 30 at the branches 32 and which defines a discharge end in communication with the piece of porous material 5″ as can be seen very clearly in FIG. 4. To give some idea of size, the thickness of the structure 30 as measured between the top and bottom faces is approximately in the range 2 millimeters (mm) to 3 mm. Therefore, the thickness of the gap 35 is approximately in the range 3 tenths of a millimeter to 4 tenths of a millimeter. This makes it possible to impart a capillary retention characteristic to the gaps, enabling the piece of porous material 5″ to be fed continuously. The effectiveness of this is further improved because the liquid always tends to build up around the periphery of the reservoir, i.e. around the inside periphery of the structure 30. The loop-shaped configuration of the structure 30 is particularly advantageous because it guarantees that the fluid can be fed by capillary action regardless of its location inside the reservoir 36. In addition, the presence of six spring blades 33 makes it possible to extend the spring function of the dispenser and to make it more uniform. It can also be noted, as in the preceding embodiment, that the blades can be brought into the same plane, since nothing prevents them from coming into the same plane, unlike what applies in the embodiment shown in FIG. 1, in which the absorbant strip 52 extends between the two blades 13.

Another difference between the third embodiment and the second embodiment lies in the fact that the structure 30 is associated with two pieces of sheet 61′ and 62′, each of which is fixed to a respective side of the structure 30. The sheet 61′ is sealed to the top face of the component part 3′, while the sheet 62′ must be sealed to the bottom face of the component part 3′, and may also be sealed to the bottom face of the second component part 3″.

Reference is made below to the fourth embodiment of the invention shown in FIGS. 5 to 8. In this embodiment, the dispenser is made up of four component elements, namely a substantially rigid structure 40, a piece of porous material 5″′, a dispensing head 7, and one or two sheets 61″, 62″.

The sheets 61″ and 62″ may be formed integrally with each other by forming a single piece of sheet. It is then necessary merely to fold the sheet 61′ over onto the sheet 62″ so that the two sheets remain connected together along a junction edge. The two sheets 61″ and 62″ may be fixed together, e.g. by heat-sealing, over most of their peripheries so as to define a substantially central internal volume which serves as a fluid and gas reservoir 46. The two sheets 61″ and 62″ are thus sealed together and also to the dispensing head 7 which defines the spraying and dispensing orifice 70. In addition, the dispensing head 7 also forms a retaining recess 70 serving to hold the piece of porous material 5″′. Thus, the two sheets 61″′ and 62″ together with the dispensing head 7 define the reservoir 46 which communicates with the outside through the dispensing orifice 70 only.

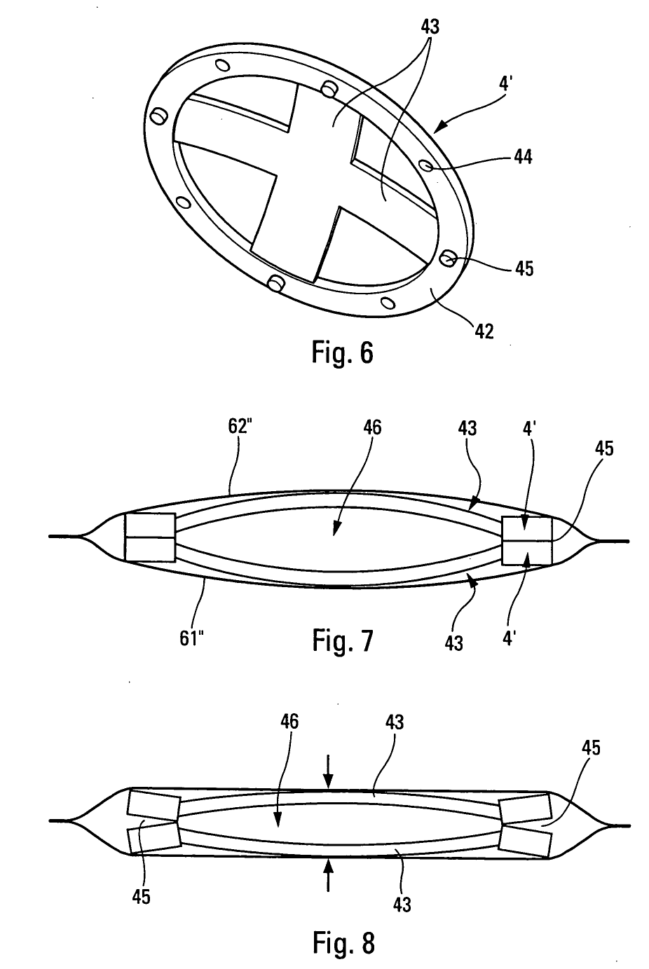

The substantially rigid structure 40 used in this embodiment is disposed inside the reservoir 46 without being fixed therein. However, it is possible to make provision for one or both of the sheets also to be fixed to the structure 40. The structure 40 in this example forms an annular shape comprising a ring 42 inside which a cross 43 extends which is made in elastically deformable manner so as to impart a resilient return characteristic to the cross. Therefore, the cross 43 performs the same return spring function as the blades in the preceding embodiments. Similarly, the structure 40 is made up of two component parts 4′ which are entirely identical in this example. FIG. 6 shows one of the two component parts 4′ . Each part 4′ comprises a ring portion 42 in which a cross extends 43. In addition, the ring 42 is provided with a series of studs 45 and of holes 44 that make it possible to connect the two component parts 4′ together well. Preferably, the two parts 4′ are mounted one on the other with the crosses 43 disposed in offset manner, as shown in FIG. 5. This imparts better distribution of the return spring characteristic over the entire ring. Preferably, each cross 43 curves in a different direction so that, at rest, the two crosses 43 are separated as far as possible from each other. This can be seen in FIG. 7 which shows the dispenser in the rest position. In this position, the respective rings of the two component parts 4′ are in substantially snug contact so as to form between them a very thin gap 45. Conversely, whenever a pressing force is exerted, tending to bring the two crosses towards each other, as shown in FIG. 8, the respective rings of the two parts 4′ tend to move apart, thereby increasing the size of the gap 45. More precisely, since the pressing is exerted at the center of the ring, the inner edges of the respective rings remain in contact with each other, while the outer edges tend to move apart so as to form a gap of V-shaped cross-section, as can be seen in FIG. 8. Thus, each time the dispenser is actuated, the cross-section of the gap 55 varies, thereby imparting a pumping function in addition to the initial and intrinsic capillary feed function.

It should be noted that the gap 5 opens on the outside of the structure 30, i.e. around the sealing line along which the two sheets are sealed together, as shown in FIG. 5. In addition, the piece of porous material 5″′ is disposed in direct contact with the outside periphery of the ring 40, i.e. in direct contact with the gap 45 which serves as a peripheral channel for feeding by capillary action and pumping. This guarantees that the fluid is fed to the piece of porous material 5″′ from any location in the reservoir; and more particularly from the periphery of the reservoir.

This pumping function may also be integrated or present in the preceding embodiments, in which the substantially rigid structure is made up of two component parts.

In all of the embodiments, the dispensing orifice may be initially closed off with a minimum volume of gas inside the reservoir. In which case, the blades, and more generally the spring means, are compressed into a state close to their maximum compressed state.

In all of the embodiments, a capillary feed function is incorporated without adding additional parts.

1/ A fluid dispenser comprising:
a reservoir (16; 26; 36; 46) of fluid and of gas;
a spraying orifice (310; 70);
an actuating wall (61, 62; 61′; 61″; 62″) for reducing the volume of the reservoir so as to put the gas and the fluid under pressure, thereby delivering them together as a mixture through the spraying orifice; and
a piece of porous material (5; 5′; 5″; 5″′) suitable for being impregnated with the fluid and with the gas and placed in the vicinity of the spraying orifice;
said fluid dispenser being characterized in that it further comprises capillary feed means (51; 25; 35; 45) for acting by capillary action to feed the piece of porous material with the fluid contained in the reservoir, said feed means being continuously in contact with the fluid product in the reservoir.

2/ A dispenser according to claim 1, in which the capillary feed means (51) extend substantially through the middle of the reservoir (16).

3/ A dispenser according to claim 1, in which the capillary feed means comprise an absorbant wick (51) in contact with or formed by the piece of porous material (5), and extending through the reservoir (16).

4/ A dispenser according to claim 1, in which the capillary feed means (25; 35; 45) extend over at least a portion of the periphery of the reservoir.

5/ A dispenser according to claim 4, in which the feed means comprise at least one peripheral capillary channel (25; 35; 45) having a discharge end in contact with the piece of porous material (5′; 5″, 5″′).

6/ A dispenser according to claim 5, in which the capillary channel (25; 35; 45) is open over substantially its entire length so that the fluid can penetrate into said channel over a large proportion of its length.

7/ A dispenser according to claim 1, further comprising a substantially rigid structure (10; 20; 30; 40) which extends over at least a portion of the periphery of the reservoir.

8/ A dispenser according to claim 7, in which said structure (20; 30; 40) forms the capillary feed means (25; 35; 45).

9/ A dispenser according to claim 7, in which the structure (10; 20; 30) forms the spraying orifice (310).

10/ A dispenser according to claim 7, in which the structure (10; 20; 30) is provided with means for holding the porous piece (5; 5′; 5″′) in place in the reservoir (16; 26; 36).

11/ A dispenser according to claim 7, in which the structure (10; 20; 30; 40) forms support means (12; 22; 32; 42) for supporting return spring means (13; 23; 33; 43) suitable for returning the actuating wall towards a rest position corresponding to the maximum volume of the reservoir.

12/ A dispenser according to claim 7, in which the structure (20; 30; 40) is made up of two component parts (2′, 2″; 3′, 3″; 4′) mounted one on the other, the feed means (25; 35; 45) being formed between said parts.

13/ A dispenser according to claim 12, in which the feed means comprise capillary channels (45) of cross-section that varies while the actuating wall (61″, 62″) is being actuated.

14/ A dispenser according to claim 12, in which the two component parts (4′) are identical.

15/ A dispenser according to claim 7, in which the actuating wall is formed by a flexible sheet (6) fixed in leaktight manner to said structure (10; 20; 30).

16/ A dispenser according to claim 7, in which the actuating wall is formed by a flexible sheet (61″, 62″) encasing said structure (40) in leaktight manner.

17/ A dispenser according to claim 7, in which the structure (20; 30; 40) forms two peripheral capillary channels (25; 35; 45), each of which connects to the piece of porous material (5′; 5″; 5″′) at a respective discharge end.
